(19) United States
(12) Patent Application Publication
(10) Pub. No.: US 2004/0026632 A1
(43) Pub. Date: Feb. 12, 2004

(54) Stimulable phosphor screen showing less scattering upon stimulation

(76) Inventors: Luc Struye, Mortsel (BE); Paul Leblans, Kontich (BE)

Correspondence Address: Joseph T. Guy Ph.D., Nexsen Pruet Jacobs & Pollard LLP, 201 W. McBee Avenue, Greenville, SC, 29603, US

(21) Appl. No.: 10/628,693

(22) Filed: Jul. 28, 2003

Related U.S. Application Data
(60) Provisional application No. 60/406,192, filed on Aug. 26, 2002.

(30) Foreign Application Priority Data
Aug. 2, 2002 (EP) 02102090.4

(51) Int. Cl. G03B 42/08

(52) U.S. Cl. 250/484.4

(57) ABSTRACT

A stimulable phosphor screen or panel has been described, wherein said stimulable phosphor screen or panel comprises a phosphor layer and a support characterized in that an intermediate layer arrangement of an X-ray absorbing foil or layer and, farther from the support, a stimulated light reflecting foil is present between said support and said phosphor layer.

### FIELD OF THE INVENTION

The present invention relates to a method for storing and reproducing a radiation image, making use of a radiation image storage sheet or panel and to a radiation image storage screen or panel with a stimulable phosphor layer and a layer arrangement suitable for use in the said radiation image storing and reproducing method.

### BACKGROUND OF THE INVENTION

As a method replacing conventional radiography, radiation image storing and reproducing methods have been proposed, making use of an image storage screen or panel, known as comprising a sheet or layer comprising a stimulable phosphor. The method thereby comprises the steps of causing the stimulable phosphor of the storage panel to absorb radiation energy having passed through an object or having radiated from an object; sequentially exciting the stimulable phosphor with an electromagnetic wave such as visible light or infrared rays (i.e., stimulating light) in order to release the radiation energy stored in the phosphor as light emission (i.e., stimulated emission); photoelectrically detecting the emitted light to obtain electric signals; and reproducing the radiation image of the object as a visible image from the electric signals. In order to be repeatedly employed the panel is further subjected to a step for erasing radiation energy remaining therein, and then stored for the next image storing and reproducing procedure.

So in U.S. Pat. No. 3,859,527 e.g. a method for producing X-ray images with a photostimulable phosphor, which are incorporated in a panel, is disclosed. The panel is exposed to incident pattern-wise modulated X-ray beam and as a result thereof the phosphor temporarily stores energy contained in the X-ray radiation pattern. At some interval after the exposure, a beam of visible or infra-red light scans the panel in order to stimulate the release of stored energy as light that is detected and converted to sequential electrical signals which are processed in order to produce a visible image. For this purpose the phosphor should store as much as possible of the incident X-ray energy and emit as little as possible of the stored energy until stimulated by the scanning beam. This is called “digital radiography” or “computed radiography”.

In applications for digital radiography image quality is very important. A high image definition and a low noise level is highly desired. Image definition (sharpness) is, to a large extent, defined by scattering properties of the phosphor layer. As a consequence thereof phosphor layer thickness is limited by the desired sharpness. More particularly in mammographic applications sharpness should be extremely high in order to have an image having high enough a diagnostic value, without leaving any doubt with respect to presence or absence of microcalcifications, in order to furthermore avoid retakes. Phosphor layer thicknesses should therefore not exceed 150 μm in order to get the desired sharpness or image definition. In praxis however it has been established that image definition does not reach the expected level and that although all measures have been taken in order to reach it, an unexpectedly lower level is attained.

The image quality that is produced by any radiographic system using a phosphor screen, thus also by a digital radiographic system, largely depends on the construction or layer arrangement of the phosphor screen. In general the thinner a phosphor screen at a given amount of absorption of X-rays, the better the image quality will be. This means that the lower the ratio of binder to phosphor of a phosphor screen, the better the image quality, attainable with that screen, will be. Optimum sharpness can thus be obtained when screens without any binder are used. Such screens can be produced e.g. by physical vapor deposition, which may be thermal vapor deposition, sputtering, electron beam deposition or other of phosphor material on a substrate. However, this production method can not be used in order to produce high quality screens with every arbitrary phosphor available. The mentioned production method leads to the best results when phosphor crystals with high crystal symmetry and simple chemical composition are used.

The use of alkali metal halide phosphors in storage screens or panels is well known in the art of storage phosphor radiology and the high crystal symmetry of these phosphors makes it possible to simultaneously provide structured screens and binderless screens.

It has been disclosed that when binderless screens with alkali halide phosphors are produced it is beneficial to have the phosphor crystal deposited as some kind of piles, needles, tiles, etc. In U.S. Pat. No. 4,769,549 it has been disclosed that the image quality of a binderless phosphor screen can be improved when the phosphor layer has a block structure shaped in fine pillars. In U.S. Pat. No. 5,055,681 a storage phosphor screen comprising an alkali halide phosphor in a pile-like structure has been disclosed. The image quality of such screens needs still to be increased and in JP-A 06-230198 it is disclosed that the surface of the screen with pillar like phosphors is rough and that a levelling of that surface can increase its sharpness. In U.S. Pat. No. 5,874,744 attention is drawn to the index of refractivity of the phosphor used to produce the storage phosphor screen with needle-like or pillar-like phosphors.

In EP-A 1,113,458 a binderless storage phosphor screen has been disclosed that comprises an alkali metal storage phosphor characterized in that said screen shows an XRD-spectrum with a (100) diffraction line having an intensity I₁₀₀ and a (110) diffraction line having an intensity I₁₁₀, so that I₁₀₀/I₁₁₀≧1. Such a phosphor screen shows a better compromise between speed and sharpness.

Although all screens disclosed in this prior art can yield X-ray images with good quality, the need for a still better compromise between speed of the recording system (i.e. as low as possible a patient dose) and an image with high sharpness and low noise is still there.

### OBJECTS AND SUMMARY OF THE INVENTION

It is an object of the present invention to provide a stimulable phosphor screen useful in an X-ray recording system with an excellent compromise between speed of the recording system (i.e. as low as possible patient dose) and an image with high sharpness and low noise as normally expected.

The above mentioned object has been realized by providing a stimulable phosphor screen having the specific features defined in claim 1. Specific features for preferred embodiments of the invention are disclosed in the dependent claims.

Further advantages and embodiments of the present invention will become apparent from the following description and drawings.

### BRIEF DESCRIPTION OF THE DRAWINGS

FIG. 1 shows a storage phospor panel having a lead foil as an intermediate layer between support (PET, Al, Glass, Amorphous Carbon) and phosphor layer, coated with a stimulable phosphor (BaFBr:Eu, CsBr:Eu)

FIG. 2 shows a panel having a layer of lead glass between a conventional phosphor layer (with CsI:Eu as conventional phosphor) and an electronic detector (CCD, Diode array).

### DETAILED DESCRIPTION OF THE INVENTION

It has been found that, to an unexpected extent, sharpness is not only determined by the scattered radiation passing the phosphor layer and depending on the content and thickness of that layer, but to an even more important extent to scattering of radiation once impinging upon and passing the support layer or undercoat layer, which may be the same or different.

Whereas in the storage phosphor layer scattering properties are normally related with radiation in the wavelenght range of visible stimulated light, the support or undercoat layer may cause scattering of X-rays, effecting the said support or undercoat layer, a phenomenon also known as “backscattering”.

The said “backscattering” is generated in all layers, known as “supporting” or “undercoating”, wherein said undercoating layers may be between the supporting and the phosphor layers as intermediate layers.

These considerations having been taken in mind and moreover having the knowledge that the undercoat layer or support is not strongly absorbing X-rays, it is clear that X-rays are penetrating to a remarkable depth into the layers under the phosphor layer(s), and that “backscattering” appears in all layers farther from the radiation source than the phosphor layer. In other words, “backscattering” provokes “exposure of more than one pixel” and lays burden on the expected sharpness as really attained. As a result loss in sharpness is found to occur.

Following solutions have been found in order to get rid of the “backscattering loss factor” described above.

According to the present invention a stimulable phosphor screen or panel comprises a phosphor layer and a support, characterized in that an intermediate layer arrangement of an X-ray absorbing foil or layer and, farther from the support, a stimulated light reflecting foil is present between said support and said phosphor layer. The said layer arrangement strongly absorbs X-rays, when said layer arrangement is present between phosphor layer and underlying support layer, moreover providing a substantially improved sharpness. This result can be interpreted to be due to the smaller distance over which “backscattering” is set free in order to effect “neighbouring pixels”. As a strongly absorbing material for the said intermediate layer lead or a lead compound is highly preferred. According to the present invention a stimulable phosphor screen or panel is provided, wherein said intermediate layer arrangement comprises an X-ray absorbing layer,wherein as a lead compound an oxide or a hydroxide of lead metal is dispersed in a binder and wherein said binder containing the lead compound is a matrix of a polycondensation product of a metal alkoxide species. It has been established that it is sufficient to have a material in the intermediate layer arrangement as set forth above, wherein the said material may be absorbing X-rays to a lower extent, but wherein it nevertheless avoids scattering to a great extent. As a consequence presence of less scattered light is not related with a real “depth” where scattered radiation is generated as no more than one pixel is overlapped by said “scattering”.

In a further preferred embodiment according to the present invention a stimulable phosphor screen or panel is provided, wherein said binder containing the lead compound is a matrix of an inorganic network of alkoxymetal substituted organic polymers or copolymers matrix.

In a still further preferred embodiment according to the present invention a stimulable phosphor screen or panel is provided, wherein said matrix is derived from a cross-linking agent selected from the group consisting of dialkoxysilanes, trialkoxysilanes, tetraalkoxysilanes, titanates, zirconates and aluminates; and a colloid of silica, and wherein said matrix comprises a colloid of an oxide or a hydroxide of lead metal.

From lead as such, or a lead compound as a preferred material it is also known that, from the point of view as set forth, that the amount of generated “backscattering radiation” is much lower than in a layer of e.g. aluminum or tungsten. A preferred support for the preferred intermediate layer arrangement therefore is amorphous carbon(a-C), not only thanks to the black, radiation absorbing particles, but, to a more remarkable extent, thanks to the generation of very little backscattering.

As a result presence of a thin intermediate layer comprising an intermediate layer arrangement as set forth above, supported by amorphous carbon is highly recommended. Although it is known in the art that a “thick” layer, foil or screen of lead may be present in a cassette wherein a phosphor plate is present, said foil or screen is known to have been situated at a distance far from the phosphor layer and not as a coated layer between said phosphor layer and the support layer of the said phosphor layer. It was moreover found now that including an amorphous carbon film as a support did open perspectives in order to produce a binderless storage phosphor screen on a support with low X-ray absorption, and low “backscattering” even if the storage phosphor layer is applied by vacuum deposition at fairly high temperatures. Amorphous carbon film supports suitable for use in the present invention are commercially available through, e.g., Tokay Carbon Co, LTD of Tokyo, Japan or Nisshinbo Industries, Inc of Tokyo, Japan, where they are termed “Glass-Like Carbon Film”, or “Glassy Carbon”. Amorphous carbon is moreover suitable to be applied in the production of binderless phosphor screens by means of chemical vapor deposition in vacuum, as the support on which the phosphor is deposited can be heated up to a temperature of about 400° C., thus requiring use of a thermostable support. Therefore, though being a support containing only elements with a low atomic number, a polymeric support may be applied, but is not the most suitable, opposite to more preferred amorphous carbon supports.

In a phosphor panel or screen according to the present invention, the thickness of the amorphous carbon layer may range from 100 μm up to 3000 μm, a thickness between 500 μm and 2000 μm being preferred as a compromise between flexibility, strength and X-ray absorption. The phosphor screens or panels as described in EP-Application No. 02100764, filed Jun. 28, 2002, provided with a lead foil as an intermediate layer between the said a-C layer support and the phosphor layer are thus highly preferred within the scope of the present invention.

Otherwise it is advantageous to provide stimulable phosphor screens with a substrate, characterized in that said substrate has a reflectivity of more than 80% as disclosed in in EP-Application No. 02100763, filed Jun. 28, 2002. Said reflectivity is preferably provided by an aluminum layer. Also in U.S. Pat. No. 4,618,778 it has also been disclosed to add a reflecting layer under the layer containing the phosphor dispersed in a binder as is, in a particular embodiment of the present invention, applied herein.

In U.S. Pat. Nos. 4,769,549 and 4,963,751 wherein storage phosphor screens with binderless, vapor deposited phosphor layers are disclosed, it is suggested that in such screens the compromise between speed and sharpness is so good, that it is not required to include special measures for further increasing the compromise between sharpness and speed, but from the teachings of in EP-A 1 316 971, it has advantageously been learnt that even with binderless stimulable phosphor screens with vapor deposited phosphors, already showing high speed combined with high sharpness, a better speed/sharpness compromise could indeed be reached when the screen layer arrangement comprises a support covered with a layer absorbing the stimulating light up to more than 30% and reflecting at least 60% of the stimulated light. Depending on the needs the balance between reflecting and absorbing properties of the system should be optimized: when priority is given to a high speed a reflectance of 80% will be strived at, whereas, when a higher sharpness is envisaged (as e.g. in mammographic systems) reflection should be lower but an absorption of up to 80% will be required.

According to the present invention the lead containing layer covering the support absorbs at least 80% (in mammographic applications) of the stimulating light and reflects at least 80% (in generally applied radiography) of the stimulated light. In a particular embodiment the said layer is covered with an adjacent thin layer, e.g. an aluminum or another reflecting layer, in order to reach, or even to exceed the reflection values set forth above. As a layer of lead has reflecting properties, use can be made thereof as such, in order to further optimize the layer arrangements in the storage phosphor panel, and in order to get an optimized image definition. In a most preferred embodiment with respect to reflecting properties, use is advantageously made of a strong X-ray absorbing lead foil in combination with a thin reflecting aluminum foil.

So according to the present invention a stimulable phosphor screen or panel is provided, wherein said intermediate layer arrangement comprises as an X-ray absorbing layer a layer of lead or a layer with a lead compound in a binder,as disclosed hereinbefore, and an aluminum layer as a stimulated light reflecting foil.

As is known in the art of the manufacture of storage screens, wherein storage phosphors are dispersed in a binder, coloring the screen is applied in favor of increasing sharpness. So e.g. in U.S. Pat. Nos. 4,394,581 and 4,491,736 such screens are disclosed. In the present invention however it is understood that although the support may be colored, presence of a layer of lead or a lead compound in an intermediate layer arrangement between support and phosphor layer as set forth above makes that any advantageous effect with respect to colored layers should be expected from colored phosphor layers and not from colored supports.

It is clear that storage phosphor panels are not restricted to “binderless storage phosphors” as the “vapor deposited phosphors” further, throughout this text, meant as phosphors produced by any method selected from the group consisting of thermal vapor deposition, chemical vapor deposition, electron beam deposition, radio frequency deposition and pulsed laser deposition. This vapor deposition is preferably carried out under conditions as described in EP-A-1 113 458.

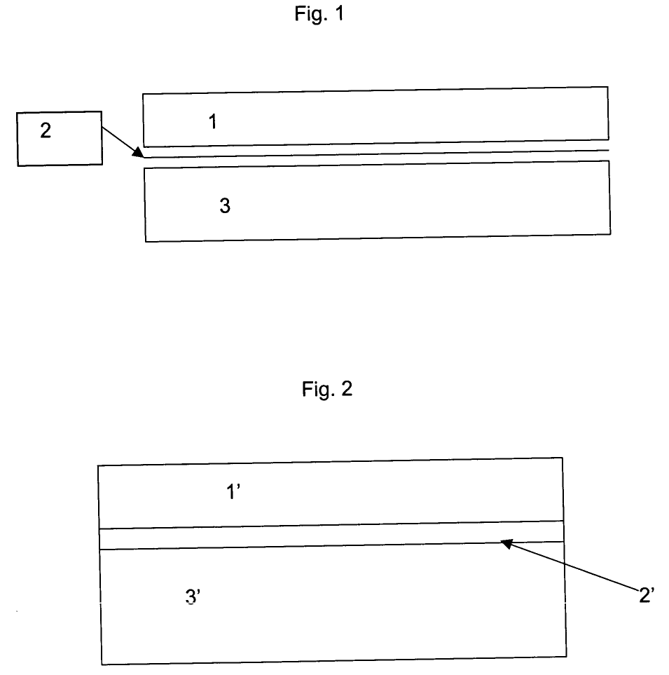

Also conventional phosphors as the conventional CsI:Eu scintillator phosphor as in FIG. 2 may be used wherein in that panel, in a particular embodiment a layer of lead glass (2′) between a conventional phosphor layer (1′) with CsI:Eu as a conventional phosphor and an electronic detector (CCD, Diode array) as layer (3′) is illustrating a panel according to the present invention. Apart for the said conventional phosphors, well-known storage phosphors as e.g. BaFBr-type phosphors known from U.S. Pat. No. 5,514,298, may be advantageously applied in a panel as set forth in FIG. 1, showing a storage phospor panel having a lead foil as an intermediate layer between support (3) (PET, Al, Glass, Amorphous Carbon) and phosphor layer (1), coated with a stimulable phosphor (BaFBr:Eu, CsBr:Eu), wherein lead/lead compound foil (2) is situated as an intermediate layer in between phosphor layer (1) and support (3).

Preferred supports for a storage phosphor screen of the present invention are selected from the group consisting of ceramics, glass, polymeric film and amorphous carbon as set forth hereinbefore, without however excluding aluminum, as its function is differing from the preferred light-reflecting thin aluminum layer farther from the aluminum support than the layer containing the lead or lead compound in the intermediate layer arrangement between support and phosphor layer. Of the polymeric films, especially heat stable polyester films (as e.g. polyethylene terephthalate and polyethylene naphthalate) with a thickness between 100 and 1000 μm are preferred as a support in a screen according to the present invention. In order to reach the desired X-ray absorption and stimulated emission light reflection properties, the supports, used in screens of the present invention, are treated so that, apart for the desired X-ray absorbing layer as a specific layer, preferably coated with a stimulated emission light reflecting layer, a reduced amount of additional special layers should be coated on the supports in case of vapor deposition of needle-shaped phosphors.

When the support for use in a storage phosphor screen of the present invention is glass, it is preferred to use frit glass made by heating glass particles or fibres at high enough a temperature in order to fuse them together in a manner, sufficiently to form a plate. The surface of such a plate of frit glass is uneven and the profile depends on the diameter of the glass beads used to form the plate of frit glass. The X-ray absorbing layer coated thereupon may further depict the unevenness in the support for the vapor deposited phosphor layer. This may however help to tightly vapor deposit the phosphor crystals in needle-shaped form. In U.S. Pat. No. 3,976,890 a mirror structure designed to minimize damage to the mirror caused by soft X-rays has been described wherein reflective coating having a high reflectivity is deposited on a glass substrate. The reflective coating has a moderately low atomic number, like the preferred aluminum coating, in order to reduce direct susceptibility to substantial X-ray damage, and further has a high coefficient of thermal conductivity so that it is a good conductor of heat from the reflective coating to the glass substrate. As glass is known as a poor conductor of heat, and the accumulation of absorbed energy in the reflective coating may lead to crazing, melting, and vaporization, the mirror structure is designed with a heat sink coating of beryllium between the reflective coating and the glass substrate. That heat sink beryllium coating has a higher coefficient of thermal conductivity than glass so that it conducts heat away from the reflective coating, and also has an atomic number which is lower than glass so that it is subject to less X-ray energy absorption.

According to the present invention a phosphor screen or panel is provided, wherein said support is selected from the group consisting of ceramics, glass, amorphous carbon, aluminum and polymeric films.

In a particular embodiment a flexible intermediate layer arrangement comprising as an X-ray absorbing layer a layer of lead or the said layer having a lead compound (as lead oxide or hydroxide) as disclosed before; and, as a stimulated light reflecting foil adjacent thereto, an aluminum layer; is provided on a flexible, polymeric support, with an adhesive layer onto said support and the said intermediate layer arrangement, coated over said adhesive layer.

Lead or lead oxide layers have, as a particular advantage that they do not absorb moisture and that such a flexible lead or lead oxide layer coated onto a polymeric support has a reduced propensity to produce static electricity during use.

In favor of completely excluding moisture from penetrating into moisture-sensitive phosphor layers as e.g. alkali halide phosphor layers, it is however recommended that, according to the present invention a phosphor screen or panel is provided, having between said intermediate layer arrangement and the support, a moisture-repellent parylene layer. In another embodiment according to the present invention a phosphor screen or panel is provided, having between said intermediate layer arrangement and the phosphor layer a moisture-repellent parylene layer.

And even more preferred, according to the present invention a phosphor screen or panel is provided, having between said intermediate layer arrangement and the phosphor layer and between said intermediate layer arrangement and the support, a moisture-repellent parylene layer. General literature with respect to “parylene” polymer films can be found in e.g. Martin H. Kaufman, Herman F. Mark, and Robert B. Mesrobian, “Preparation, Properties and Structure of Polyhydrocar-bons derived from p-Xylene and Related Compounds,” vol. XIII, 1954, pp. 3-20 (no date) and Andreas Griener, “Poly (1,4-xylylene)s: Polymer Films by Chemical Vapor Deposition,” 1997, vol. 5, No. 1, January 1997, pp. 12-16.

“Parylene”, a generic name for thermoplastic polymers and copolymers based on p-xylylene and substituted p-xylylene monomers, has been shown to possess suitable physical, chemical, electrical, and thermal properties for use in integrated circuits. Deposition of such polymers by vaporisation and decomposition of a stable dimer, followed by deposition and polymerisation of the resulting reactive monomer, is discussed by Ashok K. Sharma in “Parylene-C at Subambient Temperatures”, published in the Journal of Polymer Science: Part A: Polymer Chemistry, Vol. 26, at pages 2953-2971 (1988). “Parylene” polymers are typically identified as Parylene-N, Parylene-C, and Parylene-F corresponding to non-substituted p-xylylene, chlorinated p-xylylene, and fluorinated p-xylylene, respectively. Properties of such polymeric materials, including their low dielectric constants, are further discussed by R. Olson in “Xylylene Polymers”, published in the Encyclopedia of Polymer Science and Engineering, Volume 17, Second Edition, at pages 990-1024 (1989). Parylene-N is deposited from non-substituted p-xylyene at temperatures below about 70-90° C. The substituted dimers are typically cracked at temperatures which degrade the substituted p-xylylene monomers, and the parylene-C and parylene-F films must be deposited at temperatures substantially lower than 30° C. The moisture-protecting coating may be adhered to one or both sides of the intermediate layer arrangement by chemical vapor deposition (CVD) or lamination. The vapor deposited or laminated film(s) are thus poly-p-xylylene film(s) deposited in vacuum or laminated. A poly-p-xylylene polymer film has repeating units in the range from 10 to 10000, wherein each repeating unit has an aromatic nuclear group, whether or not substituted. Each substituent group, if present, can be the same or different and can be any inert organic or inorganic group which can normally be substituted on aromatic nuclei. Illustrations of such substituent groups are alkyl, aryl, alkenyl, amino, cyano, carboxyl, alkoxy, hydroxylalkyl, carbalkoxy and like radicals as well as inorganic radicals such as hydroxyl, nitro, halogen and other similar groups which are normally substitutable on aromatic nuclei. Particularly preferred of the substituted groups are those simple hydrocarbon groups such as the lower alkyl such as methyl, ethyl, propyl, butyl, hexyl and halogen groups particularly chlorine, bromine, iodine and fluorine as well as the cyano group and hydrogen. These polymers are commonly formed on phosphor screens or panels by the pyrolysis and vapor deposition of di-p-xylylene. These materials are the subject of several US-Patents such as U.S. Pat. No. 3,117,168 entitled “Alkylated Di-p-Xylylenes”, U.S. Pat. No. 3,155,712 entitled “Cyanated Di-p-Xylylenes” and U.S. Pat. No. 3,300,332 entitled “Coated Particulate Material and Method for Producing Same”. Pyrolysis of the vaporous di-p-xylylene occurs upon heating the dimer from about 450° C. to about 700° C. and preferably about 550° C. to about 700° C. Regardless of the pressure employed pyrolysis of the starting di-p-xylylene begins at about 450° C. At temperatures above 700° C. cleavage of the constituent groups can occur resulting in a tri- or polyfunctional species causing cross-linking of highly branched polymers. It is preferred that reduced or subatmosphere pressures are employed for pyrolysis to avoid localized hot spots. For most operations pressures within the range of 0.0001 to 10 millimetres of Hg are practical. However desired greater pressures can be employed. Likewise inert inorganic vapor diluents such as nitrogen, argon, carbon dioxide and the like can be employed to vary the optimum temperature of operation or to change the total effective pressure of the system. The diradicals formed in the manner described above are made to impinge upon the surface of the particulate material having surface temperatures below 200° C. and below the condensation temperature of the diradicals present thereby condensing thereon and spontaneously polymerising. As a basic agent the commercially available di-p-xylylene composition sold by the Union Carbide Co. under the trademark “Parylene” is thus preferred. The preferred compositions for the protective moistureproof layer(s) covering the intermediate layer arrangement at one or both sides thereof the unsubstituted “Parylene N”, the monochlorine substituted “Parylene C”, the dichlorine substituted “Parylene D” and the “Parylene HT” (a completely fluorine substituted version of Parylene N, opposite to the other “parylenes” resistant to heat up to a temperature of 400° C. and also resistant to ultra-violet radiation, moisture resistance being about the same as the moisture resistance of “Parylene C”: see the note about “High Performance Coating for Electronics Resist Hydrocarbons and High Temperature” written by Guy Hall, Specialty Coating Systems, Indianapolis, available via www.scscookson.com. Technology Letters have also been made available by Specialty Coating Systems, a Cookson Company, as e.g. the one about “Solvent Resistance of the Parylenes”, wherein the effect of a wide variety of organic solvents on Parylenes N, C, and D was investigated. In a preferred embodiment said parylene layer(s) is(are) halogen-containing. More preferably said parylene layer is selected from the group consisting of a parylene D, a parylene C and a parylene HT layer.

Alternatively as a barrier layer present on one or both sides of the intermediate layer arrangement as set forth, a lacquer layer may be provided, wherein any of the well-known lacquers may be used to provide a thin, tough, transparent overcoat for the lead foil screen whereupon the stimulable phosphor layer may be deposited. The lacquers may be applied as a liquid by any conventional manner and dried to form a tough, smooth overcoat finish to the element. Moreover a fluorosurfactant layer may be applied on top of said lacquer layer. A polyethylene terephthalate film support coated with an adhesive, whereto an intermediate layer arrangement as set forth is applied, is advantageously laminated to this support and allowed to dry to insure good adhesion thereto. As another layer on top of the said intermediate layer arrangement, a lacquer layer comprising e.g. polymerized polyvinyl chloride may be coated and dried. A thin layer of a fluorosurfactant may then be applied over the lacquer layer and the structure dried thoroughly.

It was surprising to find that the use of an intermediate layer arrangement on a support layer as set forth hereinbefore would produce such improved results related with image sharpness, due to less scattering of incident X-rays. Furtheron the storage screen or panel of the present invention does not lay burden on the applied system with respect to moisture and curl and other undesirable side-effects like e.g. static charge. The screens not having susceptibility to absorption of moisture and further having antistatic characteristics moreover provide excellent image definition or sharpness.

Lead foils or foils of lead oxide dispersed in a binder as set forth hereinbefore are commercially available. A foil of differing thicknesses can be applied, but preferred is a foil having a thickness of from 25 μm up to 150 μm. The ultimately chosen thickness strongly depends on the application as envisaged and on the energy of the incident X-rays related therewith. A thickness for the (vapor deposited) reflecting aluminum layer is normally in the range from 0.5 up to 5 μm, more preferably about 1 μm. When a moisture-protective parylene layer is applied its thickness preferably is in the range from 0.5 up to 15 μm, and even more preferably in the range from 1.0 up to 10 μm.

A lead foil layer may, besides Pb contain other metals up to a minor extent as e.g. Sn and Sb. This lead foil is then applied to the film support using a conventional adhesive therefor. As a commercially available adhesive e.g. UK 2600 mixed with Zappon® blue and supplied by BASF, Dusseldorf, Germany, may e.g. be used. Other adhesives can also be used as long as they are compatible with the lead layer and as long as they do not interfere with the recording of an X-ray image. After application of a suitable layer of adhesive to the film support, the lead foil layer is then laminated thereto. Lead oxide dispersed in a suitable binder and coated in a layer onto the preferred polymeric support may be used as a substitutent for a lead foil. Any of the conventional binders as those used for the dispersion of phosphors in layers of intensifying screens may be used herein. Such binders include e.g. polyvinyl butyral, polyvinyl acetate, urethane, polyvinyl alcohol, polyester resins, polymethyl methacrylates and the like, and more preferably use is made therefor of binders selected from the group consisting of polyvinyl butyral, polyvinyl acetate, urethane, polyvinyl alcohol, polyester resins and polymethyl methacrylates. Conventionally, the binders are mixed with a suitable solvent and conventional wetting agents as dispersion aids of the lead oxide therein. The level of binder present should be kept low versus the dispersed lead oxide in order to provide a thin substrate coated with lead. In one embodiment a support provided with an elastomeric layer thereupon, having a metal-containing filler therein, may be used.

Apart from a polymeric support, an aluminum layer may be used coated with a layer of poly(vinylidene fluoride-hexafluoro-propylene) copolymer having a metal-containing filler, such as lead oxide, dispersed therein. As an alternative for the lead oxide a lead salt may be used, said salt being selected from the group consisting of lead carbonate, lead acetate, lead iodide, lead chloride, lead fluoride, lead sulfide, lead sulfate and lead nitrate. Lead-based paint may be used and applied by the well known coating techniques, as e.g. silk screen printing, in order to provide an embossed layer, whereupon the needle-shaped phosphor may be deposited.

Substates such as glass panes or polymeric supports, all of them suitably cleaned, may, in the alternative, be subjected to magnetron sputtering procedures from a series of target cathodes, wherein the amount of each sputter coated material may be controlled by varying the number of cathodes beneath which the supports are passed during the coating operation. So directly upon the glass surface or polymeric support may be deposited a layer of lead oxide from a lead cathode operating in an oxygen-argon environment.

In the particular application related with mammography wherein exposure with soft X-rays occurs, lead oxide layers may so be deposited to an approximate thickness of about 50 Angstroms. For all other exposures, more rich in energy, it is clear that a higher thickness of the absorbing layer is more preferred. Details about magnetron sputtering procedures can e.g. be found in

K. Wasa and S. Hayakawa, “Efficient Sputtering in a Cold-Cathode Discharge in Magnetron Geometry”, Proc. of the IEEE, 55, 2179 (December 1967).

S. D. Gill and E. Kay, “Efficient Low Pressure Sputtering in a Large Inverted Magnetron Suitable for Film Synthesis”, Review of Scientific Instruments, 36:277-282 (March 1965).

James R. Mullaly, “A Crossed-Field Discharge Device for High Rate Sputtering”, RFP-1310, The Dow Chemical Company, Nov. 13, 1969, U.S. Atomic Energy Commission Contract AT(29-1)-1106.

I. G. Kesaev and V. V. Pashkova, “The Electro Magnetic Anchoring of the Cathode Spot”, Sov. Phys. Tech. Phys., vol. 3, pp. 254-264 (1959) [English Translation of Zh. Tekh. Fiz., vol. 29, pp. 287-298 (1959)].

K. Wasa and S. Hayakawa, “Low Pressure Sputtering System of the Magnetron Type”, Rev. Sci. Inst., vol. 40(5), pp. 693-697 (1969).

A. M. Dorodnov, “Some Applications of Plasma Accelerators in Technology”, pp. 330-365 in Fisika i Primenenie Plasmennich Uskoritelej (A. I. Morosov, Ed.) Nauka i Tehnike, Minsk (1974).

J. R. Mullaly, “Crossed Field Discharge Device for High Rate Sputtering,” Research/Development, vol. 22, pp. 40, 42, and 44 (February 1971).

Sol-gel reactions have recently been used in order to prepare inorganic-organic composite materials. This general reaction, making use of hydrolysis and polycondensation of a metal alkoxide species, is preferably applied in order to provide a layer having lead oxide in the layer arrangement of the screen or panel of the present invention. According to the present invention, in a particular embodiment said binder containing the lead compound in the intermediate layer arrangement of the storage screen or panel of the present invention, is a matrix of a polycondensation product of a metal alkoxide species. Said reactions take place under the influence of a suitable catalyst as e.g. an acid, and a network is formed in the process. Further according to a preferred embodiment of the present invention said binder containing the lead compound is a matrix of an inorganic network of alkoxymetal substituted organic polymers or copolymers matrix. During the build-up of this inorganic network alkoxymetal substituted organic polymers or copolymers are also present in the reaction medium and also undergo the same polycondensation reaction as the hydrolyzed metal alkoxides and are also incorporated in the network. In a further embodiment according to the present invention said binder containing the lead compound is a matrix of an inorganic network of alkoxymetal substituted organic polymers or copolymers matrix.

Particular types of inorganic-organic composite materials are named ORMOCERS (ORganically MOdified CEramics), ORMOSILS (ORganically MOdified SILicates) or CERAMERS. Scientific literature on inorganic-organic composite materials includes:

“The synthesis, structure and property behavior of inorganic-organic hybrid network materials prepared by the sol-gel process”, Wilkes at al., Proceedings of MRS Meeting, Boston Mass., November 1989;

“Sol-gel processes II: investigation and application”, H. Reuter, Advanced Materials, 3 (1991) No 11, p. 568;

“New inorqanic-organic hybrid materials through the sol-gel approach”, Wilkes et al. , Chemistry of Materials, 1996, part VIII, p 1667-1681.

“Hybrid inorganic-organic materials by sol-gel processing of organofunctional metal alkoxides”, Schubert et al., Chem. Mater. (1995), 7, p. 2010-2027.

In one embodiment the screen or panel according to the present invention is thus provided with an intermediate layer arrangement wherein said lead compound is an oxide or a hydroxide of lead metal, 35 dispersed in a binder. In a preferred embodiment the phosphor screen or panel according to the present invention has a binder containing the lead compound in a layer comprising a cross-linked polymeric matrix, wherein said matrix is derived from a crosslinking agent selected from the group consisting of dialkoxysilanes, trialkoxysilanes, tetraalkoxysilanes, titanates, zirconates and aluminates; and a colloid of silica, and wherein said matrix comprises a colloid of an oxide or a hydroxide of lead metal. So in the alternative the support may be coated with a hydrophilic layer comprising a cross-linked polymeric matrix, wherein said matrix is derived from a cross-linking agent selected from the group consisting of dialkoxysilanes, trialkoxysilanes, tetraalkoxysilanes or, in the alternative, titanates, zirconates and aluminates; and a colloid of silica, and wherein said matrix comprises a colloid of an oxide or a hydroxide of lead metal. The amount of silica in the layer preferably is in the range from 1 up to 50 times the amount of cross-linking agent. In the cross-linked polymeric matrix use is preferably made from N-trimethoxy-N,N,N-trimethyl ammonium chloride, 3-aminopropyltriethoxysilane; a mixture of dimethyl dimethoxysilane and methyl trimethoxysilane sold as Z-6070 by the Dow Corning Company and glycidoxypropyltrimethoxysilane, without however being limited thereto.

According to the present invention a phosphor screen or panel is provided, wherein said intermediate layer arrangement has a surface that has been subjected to embossing for forming a fine concavo-convex pattern.

According to the present invention a phosphor screen or panel is provided, wherein said phosphor is a binderless phosphor, having needle-shaped crystals.

Further according to the present invention a binderless stimulable phosphor screen or panel is provided, wherein said needle-shaped phosphor crystals are crystals of an alkali metal phosphor.

In a most preferred embodiment according to the present invention a binderless stimulable phosphor screen is provided, wherein said alkali metal phosphor is a CsX:Eu stimulable phosphor, wherein X represents a halide selected from the group consisting of Br, Cl and I.

Such a binderless phosphor screen according to the present invention can be prepared by vacuum deposition of the phosphor crystals on the substrate as well as by combining (mixing) the ingredients for the phosphor (phosphor precursors) and then evaporating this mixture in order to have the phosphor formed in situ during evaporation. The phosphor in a binderless phosphor screen according to the present invention can be any stimulable phosphor known in the art. Preferably the storage phosphor used in binderless phosphor screens phosphor is a binderless phosphor, having needle-shaped crystals and in an even more preferred embodiment said needle-shaped phosphor crystals are crystals of an alkali metal phosphor.

Very suitable phosphors are, e.g., phosphors according to the formula I:

M¹⁺X.aM²⁺X′₂bM³⁺X″₃:cZ (I)

wherein:

M¹⁺ is at least one member selected from the group consisting of Li, Na, K, Cs and Rb,

M²⁺ is at least one member selected from the group consisting of Be, Mg, Ca, Sr, Ba, Zn, Cd, Cu, Pb and Ni,

M³⁺ is at least one member selected from the group consisting of Sc, Y, La, Ce, Pr, Nd, Pm, Sm, Eu, Gd, Tb, Dy, Ho, Er, Tm, Yb, Lu, Al, Bi, In and Ga,

Z is at least one member selected from the group Ga¹⁺, Ge²⁺, Sn²⁺, Sb³⁺ and As³⁺, X, X′ and X″ can be the same or different and each represents a halogen atom selected from the group consisting of F, Br, Cl, I and 0≦a≦1, 0≦b≦1 and 0<c≦0.2. Such phosphors have been disclosed in, e.g., U.S. Pat. No. 5,736,069.

Highly preferred phosphors for use in a binderless phosphor screen of the present invention are CsX:Eu stimulable phosphors, wherein X represents a halide selected from the group consisting of Br, Cl and I.

Most preferably said phosphors are prepared by a method comprising the steps of:

mixing said CsX with an amount of between 10⁻³ and 5 mole % of a Europium compound selected from the group consisting of EuX′₂, EuX′₃ and EuOX′, X′ being a member selected from the group consisting of F, Cl, Br and I;

firing said mixture at a temperature above 450° C.;

cooling said mixture and

recovering the CsX:Eu phosphor.

Most preferably a CsBr:Eu stimulable phosphor is used, wherein said phosphor is prepared by the method comprising the steps of:

mixing said CsX with an amount of between 10⁻³ and 5 mole % of a Europium compound selected from the group consisting of EuX′2, EuX′3 and EuOX′, X′ being a member selected from the group consisting of F, Cl, Br and I;

firing said mixture at a temperature above 450° C.;

cooling said mixture and

recovering the CsX:Eu phosphor.

The binderless screen is advantageously prepared by bringing the finished phosphor on the support by any method selected from the group consisting of thermal vapor deposition, chemical vapor deposition, electron beam deposition, radio frequency deposition and pulsed laser deposition. It is also possible to bring the alkali metal halide and the dopant together and depositing them both on the support in such a way that the alkali metal phosphor is doped during manufacturing the screen.

The method for manufacturing a phosphor screen according to the present invention containing a CsX:Eu stimulable phosphor layer, wherein X represents a halide selected from the group consisting of Br, Cl and I thus comprises the steps of:

bringing multiple containers of said CsX and a Europium compound selected from the group consisting of EuX′₂, EuX′₃ and EuOX′, X′ being a halide selected from the group consisting of F, Cl, Br and I in condition for vapor deposition and

depositing, by a method selected from the group consisting of thermal vapor deposition, chemical vapor deposition, electron beam deposition, radio frequency deposition and pulsed laser deposition, both said CsX and said Europium compound on a substrate in such a ratio that on said substrate a CsX phosphor, doped with an amount between 10⁻³ and 5 mole % of Europium, is formed.

The deposition can proceed from a single container containing a mixture of the starting compounds in the desired proportions. Thus the method further encompasses a method for manufacturing a phosphor screen containing a CsX:Eu stimulable phosphor, wherein X represents a halide selected from the group consisting of Br, Cl and I comprising the steps of:

mixing said CsX with an amount between 10⁻³ and 5 mole % of a Europium compound selected from the group consisting of EuX′₂, EuX′₃ and EuOX′, X′ being a halide selected from the group consisting of F, Cl, Br and I;

bringing said mixture in condition for vapor deposition and

depositing said mixture on a substrate by a method selected from the group consisting of physical vapor deposition, thermal vapor deposition, chemical vapor deposition, electron beam deposition, radio frequency deposition and pulsed laser deposition.

Apart for applications in “needle-shaped phosphors”, and more particularly, in applications with particularly preferred columnar CsBr:Eu needles, screens or panels coated with “powdered phosphors” in general radiographic diagnosis are envisaged. Even more particularly its application in mammography is envisaged for the reason already set forth hereinbefore, the more as the phosphor layer should be very thin (in the range of about 150 μm) so that X-rays are easily passing through the phosphor layer, thereby generating much more backscattering radiation in the layers underlying the phosphor layer, wherein said backscattering is reduced to a desired low level by the screens or panels according to the present invention as set forth hereinbefore.

Furtheron, apart for applications in digital radiography, “direct radiography” is also envisaged. In such an application, wherein an electronic detector is in direct contact with an electronic detector, direct processing of the signals is obtained, as has already been illustrated in FIG. 2. In an analogous way it is understood that sharpness is not only determined for such a direct radiographic system by the thickness of the phosphor layer, but also by the scattering properties of the underlying diode array of CCD's. An additional requirement is presence of a transparent foil, which cannot form a problem if e.g. use is made of lead glass: application of a thin layer (see layer (2′) in FIG. 2) thereof between phosphor layer and electronic detector will improve sharpness to a remarkable extent.

The invention moreover includes a storage phosphor panel manufacturing method or procedure comprising the steps of

providing a suitable support(e.g. a preferred amorphous carbon film) coated with an intermediate layer arrangement of a lead or lead compound containing sheet or foil, provided with an aluminum reflecting layer, as a substrate material for the phosphor plate or panel, optionally coated with a moisture-repellent parylene layer;

vacuum depositing a storage phosphor layer onto said substrate material and, optionally covering said phosphor layer with a moisture-repellent parylene layer;

optionally laminating a polymeric film on the side of the substrate material not covered by said phosphor.

The invention further includes a method for producing a storage phosphor panel comprising the steps of:

providing a suitable support(e.g. an amorphous carbon film) coated with an intermediate layer arrangement of a lead or lead compound containing sheet or foil,

applying a specularly reflecting layer thereupon,

further vacuum depositing a storage phosphor layer on said reflecting layer, and

optionally laminating a polymeric film on the side of the reflecting layer not covered by said phosphor.

The invention further includes a method for producing a storage phosphor panel comprising the steps of:

providing a suitable support(e.g. an amorphous carbon film) coated with an intermediate layer arrangement of a lead or lead compound containing sheet or foil, provided with an aluminum reflecting layer,

applying a specularly reflecting layer thereupon,

chemical vacuum depositing a moisture repellent layer (preferably a parylene layer) on top of said specularly reflecting layer.

further vacuum depositing a storage phosphor layer on said reflecting layer, optionally polishing said phosphor layer, and, furtheron, optionally,

laminating a polymeric film on the side of the amorphous carbon film not covered by said phosphor.

The screen or panel of the present invention moreover may include on top of the phosphor layer any protective layer known in the art. Especially suitable however for use are those protective layers disclosed in EP-Application No. 02100297, filed Mar. 26, 2002; and EP-A's 1 316 969 and 1 316 970.

In order to provide an image storage panel having high surface durability, i.a. avoiding damaging of the surface by stain and abrasion after multiple use, further in favor of ease of manipulation, excellent image quality (improved sharpness) without screen structure noise increase the radiation image storage panel comprises a protective coating characterized in that, besides a binder, the said protective coating comprises a white pigment having a refractive index of more than 1.6, more preferably a refractive index of more than 2.0, and even more defined, titanium dioxide, which is present in the said binder, optionally further comprising a urethane acrylate, and wherein said protective coating has a surface roughness (Rz) between 2 μm and 10 μm as disclosed in EP-A 1 318 525.

In the alternative the protective layer is composed of a polymeric compound selected from the group consisting of vinyl resins comprising moieties derived from esters of acrylic acid and vinyl resins comprising moieties derived from esters of methacrylic acid and, even more preferably, a thermoplastic rubber as disclosed in EP-Application No. 02 100 235, filed Mar. 8, 2002. In favor of sharpness the polymer further comprises at least one colorant, and more preferably, a colorant having same absorption characteristics with respect to stimulating radiation as the colorant deposited by chemical vapor deposition as described above.

As an outermost layer, a parylene layer is highly desired as moisture proof layer as has e.g. been described in EP-A's 1 286 362, 1 286 363 and 1 286 364. In still another embodiment according to the present invention a binderless photostimulable phosphor screen is provided, overcoated with a vacuum deposited protective layer of poly(p-xylylene) (=parylene), poly(p-2-chloro-xylylene), poly(p-2,6-dichloroxylylene) and fluoro substituted poly(p-xylylene), MgF₂, or a combination thereof. As chemical vapor deposition is a technique that can be applied when making use of those components, the said technique is advantageously applied in this case. “Parylene” thereby particularly provides excellent moisture resistance, whereas MgF₂ offers excellent anti-reflecting properties.

The screen or the panel of the present invention can also have reinforced edges as described in, e.g., U.S. Pat. Nos. 5,334,842 and 5,340,661.

The surface of the phosphor layer (1) in a panel or screen of the present invention can be made smaller than the surface of the support (2) so that the phosphor layer does not reach the edges of the support. Such a screen has been disclosed in, e.g., EP-Application No. 02100297, filed Mar. 26, 2002.

The present invention moreover includes a method for exposing an object to X-rays comprising the steps of:

providing an X-ray machine including an X-ray tube equipped for emitting X-rays with an energy lower than or equal to 70 keV and a phototimer coupled to said X-ray tube for switching said tube on and off in accordance with an X-ray dose reaching said phototimer,

placing an object between said X-ray tube and said phototimer

placing a binderless storage phosphor panel or screen according to the present invention between said object and said phototimer and

activating said X-ray tube for exposing said object, said cassette and said phototimer until said phototimer switches said X-ray tube off.

Having described in detail preferred embodiments, it is clear that those embodiments should not be limited thereto.

1. A stimulable phosphor screen or panel comprising a phosphor layer and a support characterized in that an intermediate layer arrangement of an X-ray absorbing foil or layer and, farther from the support, a stimulated light reflecting foil is present between said support and said phosphor layer.

2. A stimulable phosphor screen or panel according to claim 1, wherein said intermediate layer arrangement comprises an X-ray absorbing layer, wherein as a lead compound an oxide or a hydroxide of lead metal is dispersed in a binder and wherein said binder containing the lead compound is a matrix of a polycondensation product of a metal alkoxide species.

3. A stimulable phosphor screen or panel according to claim 2, wherein said binder containing the lead compound is a matrix of an inorganic network of alkoxymetal substituted organic polymers or copolymers matrix.

4. A stimulable phosphor screen or panel according to claim 3, wherein said matrix is derived from a cross-linking agent selected from the group consisting of dialkoxysilanes, trialkoxysilanes, tetraalkoxysilanes, titanates, zirconates and aluminates; and a colloid of silica, and wherein said matrix comprises a colloid of an oxide or a hydroxide of lead metal.

5. A stimulable phosphor screen or panel according to claim 1, wherein said intermediate layer arrangement comprises, as an X-ray absorbing layer a layer of lead.

6. A stimulable phosphor screen or panel according to claim 1, wherein as a stimulated light reflecting foil an aluminum layer is present.

7. A stimulable phosphor screen or panel according to claim 2, wherein as a stimulated light reflecting foil an aluminum layer is present.

8. A stimulable phosphor screen or panel according to claim 3, wherein as a stimulated light reflecting foil an aluminum layer is present.

9. A stimulable phosphor screen or panel according to claim 4, wherein as a stimulated light reflecting foil an aluminum layer is present.

10. A stimulable phosphor screen or panel according to claim 5, wherein as a stimulated light reflecting foil an aluminum layer is present.

11. A phosphor screen or panel according to claim 1, wherein said support is selected from the group consisting of ceramics, glass, amorphous carbon, aluminum and polymeric films.

12. A phosphor screen or panel according to claim 6, wherein said support is selected from the group consisting of ceramics, glass, amorphous carbon, aluminum and polymeric films.

13. A phosphor screen or panel according to claim 1, wherein said intermediate layer arrangement has a surface that has been subjected to embossing for forming a fine concavo-convex pattern.

14. A phosphor screen or panel according to claim 6, wherein said intermediate layer arrangement has a surface that has been subjected to embossing for forming a fine concavo-convex pattern.

15. A phosphor screen or panel according to claim 11, wherein said intermediate layer arrangement has a surface that has been subjected to embossing for forming a fine concavo-convex pattern.

16. A phosphor screen or panel according to claim 12, wherein said intermediate layer arrangement has a surface that has been subjected to embossing for forming a fine concavo-convex pattern.

17. A phosphor screen or panel according to claim 1, having between said intermediate layer arrangement and the support a moisture-repellent parylene layer.

18. A phosphor screen or panel according to claim 6, having between said intermediate layer arrangement and the support a moisture-repellent parylene layer.

19. A phosphor screen or panel according to claim 11, having between said intermediate layer arrangement and the support a moisture-repellent parylene layer.

20. A phosphor screen or panel according to claim 12, having between said intermediate layer arrangement and the support a moisture-repellent parylene layer.

21. A phosphor screen or panel according to claim 1, having between said intermediate layer arrangement and the phosphor layer a moisture-repellent parylene layer.

22. A phosphor screen or panel according to claim 6, having between said intermediate layer arrangement and the phosphor layer a moisture-repellent parylene layer.

23. A phosphor screen or panel according to claim 11, having between said intermediate layer arrangement and the phosphor layer a moisture-repellent parylene layer.

24. A phosphor screen or panel according to claim 12, having between said intermediate layer arrangement and the phosphor layer a moisture-repellent parylene layer.

25. A phosphor screen or panel according to claim 1, having between said intermediate layer arrangement and the phosphor layer and between said intermediate layer arrangement and the support a moisture-repellent parylene layer.

26. A phosphor screen or panel according to claim 6, having between said intermediate layer arrangement and the phosphor layer and between said intermediate layer arrangement and the support a moisture-repellent parylene layer.

27. A phosphor screen or panel according to claim 11, having between said intermediate layer arrangement and the phosphor layer and between said intermediate layer arrangement and the support a moisture-repellent parylene layer.

28. A phosphor screen or panel according to claim 12, having between said intermediate layer arrangement and the phosphor layer and between said intermediate layer arrangement and the support a moisture-repellent parylene layer.

29. A phosphor screen or panel according to claim 1, wherein said phosphor is a binderless phosphor, having needle-shaped crystals.

30. A phosphor screen or panel according to claim 6, wherein said phosphor is a binderless phosphor, having needle-shaped crystals.

31. A phosphor screen or panel according to claim 11, wherein said phosphor is a binderless phosphor, having needle-shaped crystals.

32. A phosphor screen or panel according to claim 12, wherein said phosphor is a binderless phosphor, having needle-shaped crystals.

33. A binderless stimulable phosphor screen or panel according to claim 29, wherein said needle-shaped phosphor crystals are crystals of an alkali metal phosphor.

34. A binderless stimulable phosphor screen or panel according to claim 30, wherein said needle-shaped phosphor crystals are crystals of an alkali metal phosphor.

35. A binderless stimulable phosphor screen or panel according to claim 31, wherein said needle-shaped phosphor crystals are crystals of an alkali metal phosphor.

36. A binderless stimulable phosphor screen or panel according to claim 32, wherein said needle-shaped phosphor crystals are crystals of an alkali metal phosphor.

37. A binderless stimulable phosphor screen according to claim 29, wherein said alkali metal phosphor is a CsX:Eu stimulable phosphor, wherein X represents a halide selected from the group consisting of Br, Cl and I.

38. A binderless stimulable phosphor screen according to claim 30, wherein said alkali metal phosphor is a CsX:Eu stimulable phosphor, wherein X represents a halide selected from the group consisting of Br, Cl and I.

39. A binderless stimulable phosphor screen according to claim 31, wherein said alkali metal phosphor is a CsX:Eu stimulable phosphor, wherein X represents a halide selected from the group consisting of Br, Cl and I.

40. A binderless stimulable phosphor screen according to claim 32, wherein said alkali metal phosphor is a CsX:Eu stimulable phosphor, wherein X represents a halide selected from the group consisting of Br, Cl and I.

41. A binderless stimulable phosphor screen according to claim 33, wherein said alkali metal phosphor is a CsX:Eu stimulable phosphor, wherein X represents a halide selected from the group consisting of Br, Cl and I.

42. A binderless stimulable phosphor screen according to claim 34, wherein said alkali metal phosphor is a CsX:Eu stimulable phosphor, wherein X represents a halide selected from the group consisting of Br, Cl and I.

43. A binderless stimulable phosphor screen according to claim 35, wherein said alkali metal phosphor is a CsX:Eu stimulable phosphor, wherein X represents a halide selected from the group consisting of Br, Cl and I.

44. A binderless stimulable phosphor screen according to claim 36, 10 wherein said alkali metal phosphor is a CsX:Eu stimulable phosphor, wherein X represents a halide selected from the group consisting of Br, Cl and I.
